(19) United States
(12) Patent Application Publication
(10) Pub. No.: US 2005/0201459 A1
(43) Pub. Date: Sep. 15, 2005

(54) Digital image signal decoder and decoding method

(75) Inventor: Yukio Hayashi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/070,276

(22) Filed: Mar. 3, 2005

(30) Foreign Application Priority Data
Mar. 3, 2004 (JP) 2004-58367

(51) Int. Cl. H04N 7/12

(52) U.S. Cl. 375/240.2; 375/240.24; 375/240.25

(57) ABSTRACT

An image decoder and decoding method is provided for preventing a degradation in the image quality in a resolution conversion when a compress-encoded digital image signal is decoded. A range of DCT coefficients to be decoded in IDCT processing is changed in accordance with the type of compress-encoding for each of a luminance component block and a color difference component block when an interlace image is decoded. For example, a low frequency and a high frequency area of a vertical component are extracted when a luminance component block is compress-encoded in accordance with frame DCT encoding, and a low frequency area of the vertical component is only extracted when the luminance component block is compress-encoded in accordance with field DCT encoding. Also, a low frequency area of a vertical component is only extracted when a color difference component block is compress-encoded in accordance with the frame DCT encoding, and a low frequency and a high frequency area of the vertical component are extracted when the color difference component block is compress-encoded in accordance with the field DCT encoding.

### BACKGROUND OF THE INVENTION

1. Field of the Invention

The present invention relates to a decoder and a decoding method for decoding a compress-encoded digital image signal for reproduction.

2. Description of the Related Art

For transmitting a moving image signal through a communication medium such as a wireless or a wired medium, or for storing a moving image signal in a recording medium such as a hard disk drive, the moving image signal is often encoded and compressed in view of the transmission capacity and recording capacity. For example, the encoding/compression processing such as MPEG2 (Moving Picture Experts Group 2), which is an international standard for encoding of moving images, defines compress-encoding processing based on discrete cosine transform (hereinafter called the “DCT”). The DCT is one type of orthogonal transform which harmonically analyzes spatial frequencies included in an image signal from its low frequency term to high frequency term. In the DCT processing, an image signal is processed on a block-by-block basis to calculate a DCT coefficient for each pixel, where one block is composed of (8×8) pixels. Then, a data stream of a digital image signal is formed with these DCT coefficients, and this data stream of the digital image signal is transmitted or recorded.

On the other hand, for decoding a digital image signal which is compress-encoded by the DCT processing, DCT coefficients included in the signal must undergo an inverse discrete cosine transform (hereinafter called the “IDCT”). However, the IDCT processing involves a lot of processing which is a large burden on the hardware and software configuration in a digital image signal decoder. For this reason, digital image signal decoders employ a resolution conversion for reducing the DCT coefficients which are decoded in the IDCT processing in order to alleviate the burden of the IDCT processing. The resolution conversion may also be performed to reduce DCT coefficients included in a digital image signal conforming to HDTV specification when an image signal intended for display on a high resolution display for HDTV (high definition television) is displayed on a normal low-resolution display.

Conventionally, a variety of such resolution conversions have been disclosed, as described, for example, in Laid-open Japanese Patent Application Nos. 6-22291, 2000-165885, 2000-165871, and “MPEG2 All Format Video Decoder Using VLIW-type Media Processor” (Video Information Media Transaction Vol. 56, pp. 804-813, 2002). An example of the prior art techniques will be described in connection with the resolution conversion described in “MPEG2 All Format Video Decoder Using VLIW-type Media Processor” with reference to FIG. 1. A matrix shown on the left side of FIG. 1 represents a block which stores DCT coefficients for (8×8) pixels. The upper left corner of the block represents a DC component included in the image signal, and DCT coefficients representing higher frequency components are stored in the block toward the right in the horizontal direction or downward in the vertical direction.

Assume in a compress-encoded digital image signal, a macroblock indicative of information for (16×16) pixels is formed by two combinations of four of the foregoing blocks for a luminance signal (Y-signal) and two of the foregoing blocks for color difference signals (Cb and Cr signals). Then, a collection of such macroblocks form image data for one screen. These macroblocks are multiplexed on a data stream of the digital image signal, and transmitted or stored in a time series.

The exemplary case shown in FIG. 1 illustrates a resolution conversion for reducing DCT coefficients for (8×8) pixels to one-half of the number of pixels both in the horizontal and vertical directions, where different resolution conversions are employed depending on whether a digital image to be converted is a progressive image or an interlace image. Here, the progressive image refers to an image represented by an image signal which is generated by sequentially scanning horizontal lines vertically on the screen, while the interlace image refers to an image displayed by collecting separately odd-numbered and even-numbered scanning lines, and alternately displaying a collection of odd-numbered scanning lines and a collection of even-numbered scanning lines.

In the exemplary case of FIG. 1, for converting the resolution, an analysis is first made on control information included in a header of a digital image signal. When a progressive image is determined, only low frequency components are extracted from DCT coefficients in the block, as indicated by a dotted line in FIG. 1, and are decoded in the IDCT processing (an upper right block in FIG. 1). Since fundamental wave components of the image signal are included in low frequency components of the DCT coefficients, information required for a low-resolution image can be acquired by extracting only these low-frequency components. On the other hand, when an interlace image is determined, only low frequency components are decoded with respect to the horizontal direction of the block. With respect to the vertical direction, information on different field is included in each line, so that part of low frequency components is decoded together with part of high frequency components (lower right block in FIG. 1).

### SUMMARY OF THE INVENTION

It is an object of the present invention to provide an image decoder and decoding method for alleviating a degradation in image quality involved in a resolution conversion by reducing DCT coefficients of a compress-encoded digital image signal.

According to a first aspect of the present invention, there is provided a digital image signal decoder for decoding a digital image signal including data blocks each of which is a two-dimensional array of DCT coefficients derived through a discrete cosine transform of a unit image block composed of a plurality of adjacent pixel data. The decoder is characterized by including an extracting circuit for selecting a partial area in the data block to extract the DCT coefficients included in the partial area, and a decoding circuit for decoding the extracted DCT coefficients in accordance with the discrete cosine transform to reproduce image data included in the unit image block.

According to a second aspect of the present invention, there is provided a digital image signal decoding method for decoding a digital image signal including a data block which is a two-dimensional array of DCT coefficients derived through discrete cosine transform of a unit image block composed of a plurality of adjacent pixel data. The method is characterized by including the steps of selecting a partial area in the data block to extract the DCT coefficients included in the partial area, and decoding the extracted DCT coefficients in accordance with the discrete cosine transform to reproduce image data included in the unit image block.

### BRIEF DESCRIPTION OF THE DRAWINGS

FIG. 1 is a diagram for explaining how a resolution conversion is processed in accordance with a prior art technique;

FIG. 2 is a block diagram showing an exemplary configuration of a digital image signal decoder according to the present invention;

FIG. 3 is a diagram for explaining how frame DCT encoding is performed;

FIG. 4 is a diagram for explaining how field DCT encoding is performed;

FIG. 5 is a flow chart generally showing the processing operation according to the present invention;

FIG. 6 is an explanatory diagram generally showing DCT coefficient selection/extractions 1, 2 in FIG. 5;

FIG. 7 is an explanatory diagram generally showing DCT coefficient selection/extractions 3, 4 in FIG. 5;

FIG. 8 is an explanatory diagram generally showing DCT coefficient selection/extractions 1, 2 according to another embodiment of the present invention; and

FIG. 9 is an explanatory diagram generally showing DCT coefficient selection/extractions 3, 4 according to another embodiment of the present invention.

### DETAILED DESCRIPTION OF THE INVENTION

FIG. 2 shows an embodiment of a digital image signal decoder according to the present invention. The decoder may be incorporated in a video decoder, a digital broadcasting tuner, or video devices such as a wall-mounted television, or may be an adaptor which is added to these devices.

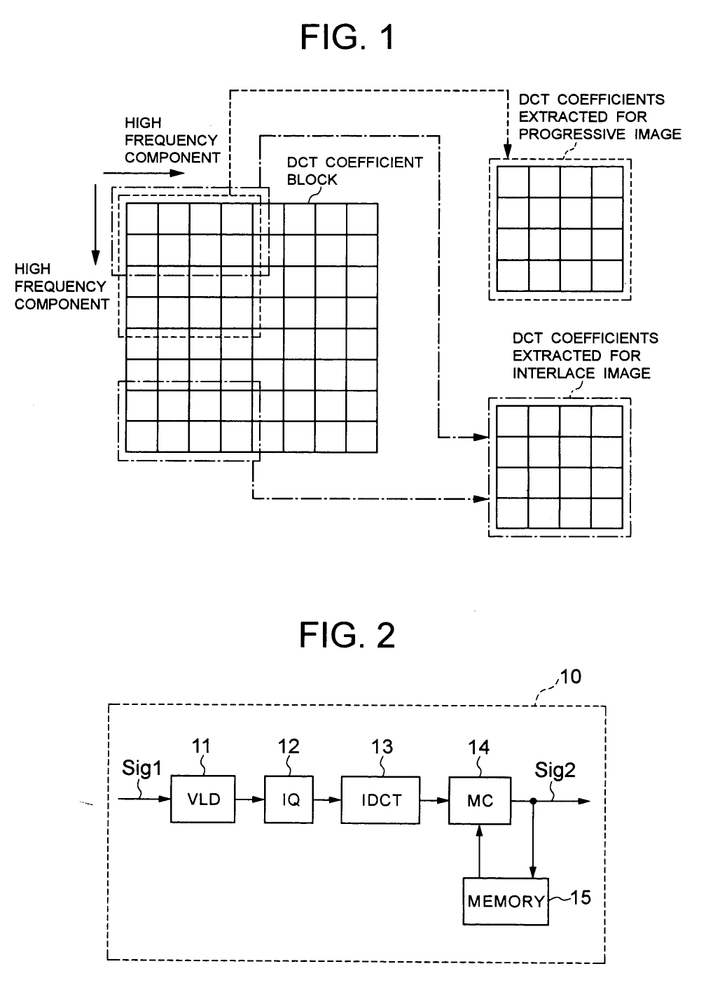

As shown in FIG. 1, the digital image signal decoder 10 mainly comprises a variable length decoding circuit 11, an inverse quantizer circuit 12, an inverse discrete cosine transform circuit 13, a motion compensation circuit 14, and a memory circuit 15.

The operation of the decoder will be described below in brief. First, an image signal Sig1 compress-encoded in accordance with MPEG2 or the like is input from a variety of circuits (not shown) previous to the decoder to the variable length decoding circuit 11. The variable length decoding circuit 11 analyzes the input signal to extract information included in the signal such as motion vectors and to extract an image data signal included in the input signal in a predetermined format, which is output to the inverse quantizer circuit 12 at the next stage. The inverse quantizer circuit 12 inversely quantizes the input image data signal, and outputs the inverse-quantized image signal to the next inverse discrete cosine transform circuit 13. The inverse discrete cosine transform circuit 13 applies the IDCT processing to the input image signal to reproduce restored image data. The present invention relates to the resolution conversion in the inverse discrete cosine transform circuit 13. Subsequently, the motion compensation circuit 14 applies a motion compensation to the restored image data output from the inverse discrete cosine transform circuit 13 using reference image data stored in the memory circuit 15, and a motion vector supplied from the variable length decoding circuit 11. Then, the motion-compensated restored image signal Sig2 is output to a variety of circuits (not shown) connected at subsequent stages of the motion compensation circuit 14.

Arrows drawn in FIG. 2 indicate the flows of main signals between the respective components. For example, signals such as a response signal, a monitor signal and the like associated with such main signals may be transferred in directions opposite to the arrows in the figure. Further, the arrows in the figure indicate conceptual flows of signals between the respective components, and each signal need not be faithfully transferred and received along the paths indicated by the respective arrows in an actual decoder.

Next, description will be made on the resolution conversion in the inverse discrete cosine transform circuit 13 based on the present invention. The feature of the present invention lies in an adjustment of a range of DCT coefficients to be decoded in the IDCT processing in accordance with the type of DCT encoding applied to an image signal during the resolution conversion when the image signal represents an interlace image.

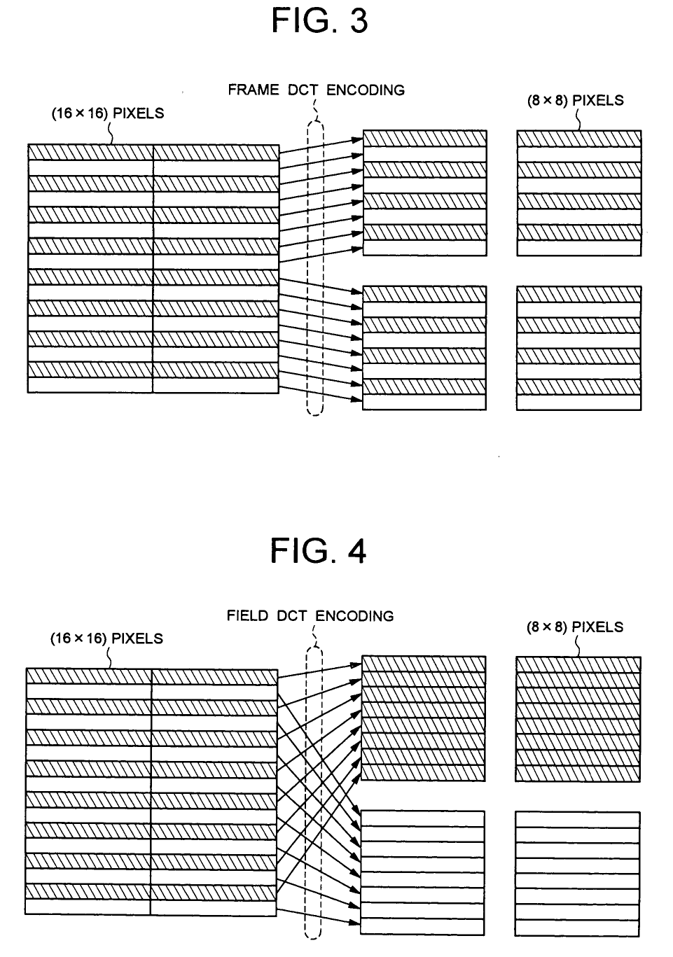

Specifically, in the DCT processing according to MPEG2 in an interlace image, frame DCT encoding or field DCT encoding is selected in units of macroblocks for compress-encoding. Then, a flag indicative of compress-encoding selected for each macroblock is added to a header of the macroblock included in a data stream of an image signal. However, such a selection of compress-encoding is applied only to a luminance component block included in the macroblock, whereas the frame DCT encoding alone is performed for a color difference component block. FIG. 3 shows how the frame DCT encoding is performed, while FIG. 4 shows how the field DCT encoding is encoded. Generally, when frequency components in the vertical direction of a macroblock are remain in a low-frequency range, the frame DCT encoding shown in FIG. 3 is selected. When the frequency components extend into a high-frequency range, the field DCT encoding shown in FIG. 4 is selected. In other words, the frame DCT encoding is employed for an image which involves few movements because there is a high correlation of the top field to the bottom field. Conversely, the field DCT encoding is selected for an image which involves violent movements because there is a low correlation of the top field to the bottom field.

Taking advantage of the difference in the DCT encoding, the present invention selects appropriate DCT coefficients for each of a luminance component and a color difference block included in a macroblock in accordance with the form of compress-encoding in the event of the resolution conversion in an interlace image.

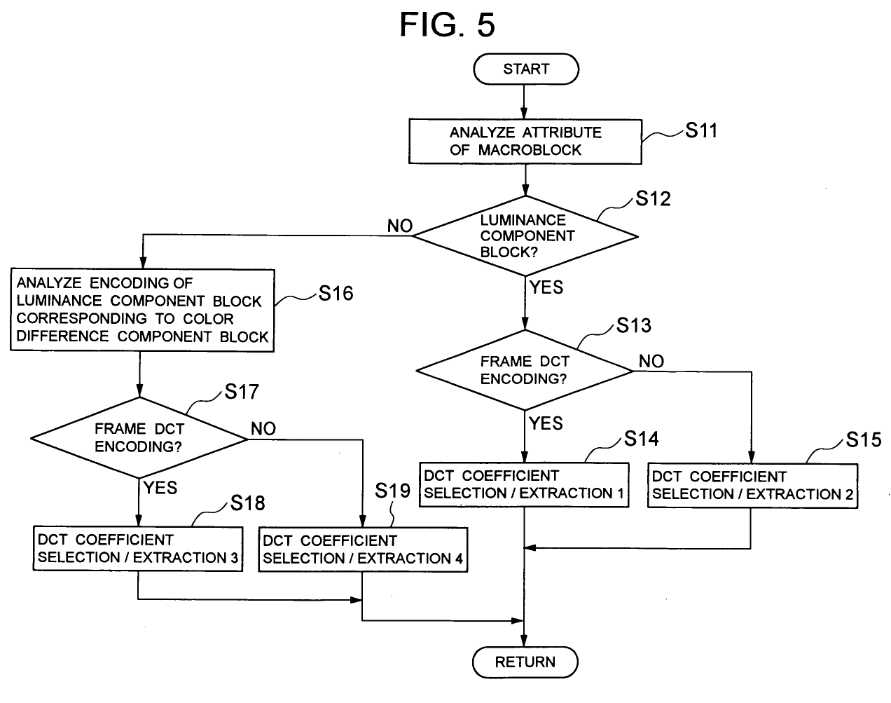

Next, the specific processing operation of the present invention will be described with reference to a flow chart shown in FIG. 5. Software-based processing represented by the flow chart may be started on a periodic basis, for example, based on a predetermined timer, or may be started in response to a particular event such as completed storage of a predetermined image signal data stream.

As the processing shown in FIG. 5 is started, the attribute of a macroblock included in an image signal data stream input to the inverse discrete cosine transform circuit 13 is determined at step S11. For reference, this determination is made by checking an indication flag included in the header of each macroblock, as previously mentioned.

When the block is determined to be a luminance component block at step S12, the processing proceeds to step S13, where the header is further analyzed to determine whether the compress-encoding applied to the block is frame DCT encoding.

When the frame DCT encoding is determined at step S13, “DCT coefficient selection 1” at the next step S14 is executed in the resolution conversion. On the other hand, when it is determined at step S13 that the encoding applied to the block is not the frame DCT encoding but is field DCT encoding, “DCT coefficient selection 2” at step S15 is executed in the resolution conversion.

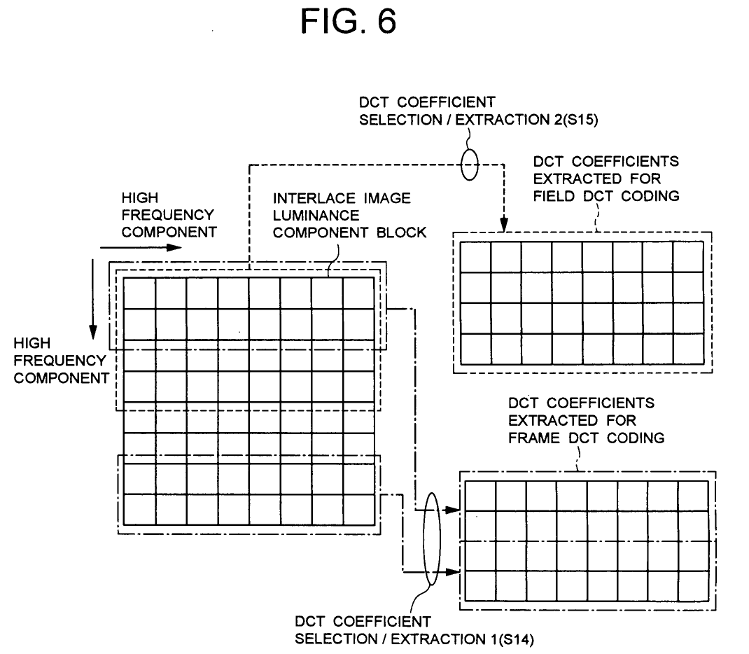

Now, the DCT coefficient selections 1, 2 will be described in brief with reference to FIG. 6. FIG. 6 shows an exemplary case where a region of DCT coefficients to be decoded in the IDCT processing is reduced to one half in vertical resolution.

A luminance component block in an interlace image includes different field information in each line in the vertical direction, as will be apparent from the foregoing description, when it is encoded in accordance with the frame DCT. For this reason, part of the low frequency components and part of high frequency components are extracted for decoding in the IDCT processing in regard to the vertical direction, as indicated by a one-dot chain line in FIG. 6 (lower right in FIG. 6) in the DCT coefficient selection 1 at step S14. On the other hand, when the luminance block has been encoded in accordance with the field DC encoding, the low frequency components alone are to be decoded in the IDCT processing, as indicated by a dotted line in FIG. 6, because the same field information is included in each line in regard to the vertical direction (upper right in FIG. 6).

On the other hand, when it is determined at step S12 in the flow chart that the concerned block is not a luminance component block, the processing proceeds to step S16. In this event, this block is a color difference component block which is compress-encoded only in accordance with the frame DCT, as mentioned above. For this reason, at step S16, encoding information for the luminance component block included in the same macroblock as the color difference block is utilized. Specifically, when the luminance component block corresponding to the color difference block has undergone the frame DCT encoding, “DCT coefficient selection 3” is executed at step S18, and otherwise, i.e., when the luminance component block has undergone the field DCT encoding, “DCT coefficient selection 4” is executed at step S19.

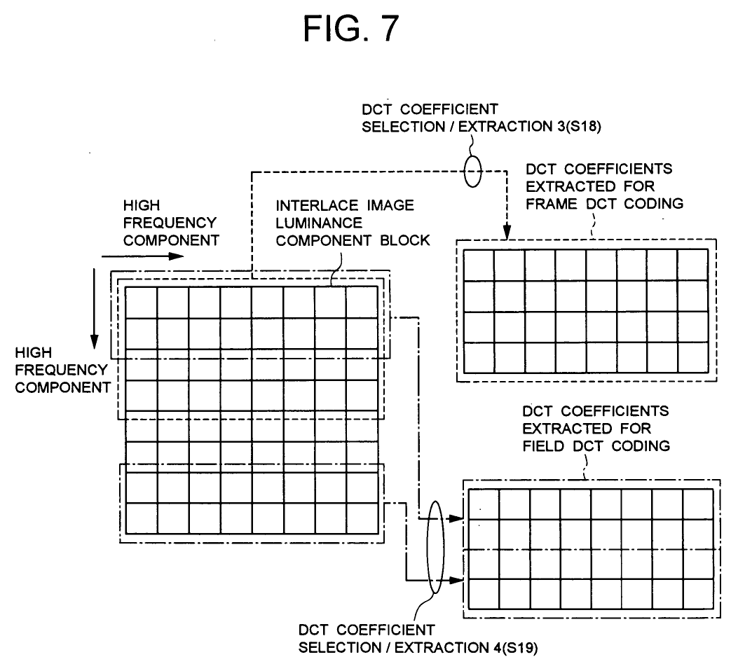

Now, the DCT coefficient selections 3, 4 will be described in brief with reference to FIG. 7. FIG. 7 shows an exemplary case where a region of DCT coefficients to be decoded in the IDCT processing is reduced to one half in vertical resolution.

First, when a luminance component block is encoded in accordance with the frame DCT encoding, there is a high correlation to the vertical direction. For this reason, at “DCT coefficient selection 3” at step S18, only low frequency components of a color difference component block corresponding to the luminance component block is subjected to the decoding, as indicated by a dotted line in FIG. 7 (upper right in FIG. 7). On the other hand, when the luminance component block has undergone the field DCT encoding, there is a low correlation to the vertical direction, so that at “DCT coefficient selection 4” at step S19, part of low frequency components and part of high frequency components of the color difference component block corresponding to the luminance component block are extracted for decoding (lower right in FIG. 7).

As described above, this embodiment is a digital image signal decoder for decoding a digital image signal including a data block which is a two-dimensional array of DCT coefficients derived through the discrete cosine transform of unit image blocks each composed of a plurality of adjacent pixel data, wherein the decoder includes the inverse discrete cosine transform circuit 13 which corresponds to an extracting circuit for selecting a partial area within the data block to extract the DCT coefficients included in the partial area, and a decoding circuit for decoding the extracted DCT coefficients in accordance with the inverse discrete cosine transform to reproduce pixel data included in the unit image blocks.

Also, this embodiment is a digital image signal decoding method for decoding a digital image signal including a data block which is a two-dimensional array of DCT coefficients derived through the discrete cosine transform of unit image blocks each composed of a plurality of adjacent pixel data, wherein the method includes steps S11 to S19 which correspond to a step of selecting a partial area within the data block to extract the DCT coefficients included in the partial area, and a step of decoding the extracted DCT coefficients in accordance with the inverse discrete cosine transform to reproduce pixel data included in the unit image blocks.

Thus, according to this embodiment, in the IDCT processing of an interlace image in the digital image signal decoder or digital image signal decoding method, a region of DCT coefficients to be decoded for each of a luminance component block and a color difference component block can be selected as appropriate in accordance with the type of compress-encoding. This can simplify the processing in the IDCT processing, and can reduce a degradation in the image quality involved in the resolution conversion.

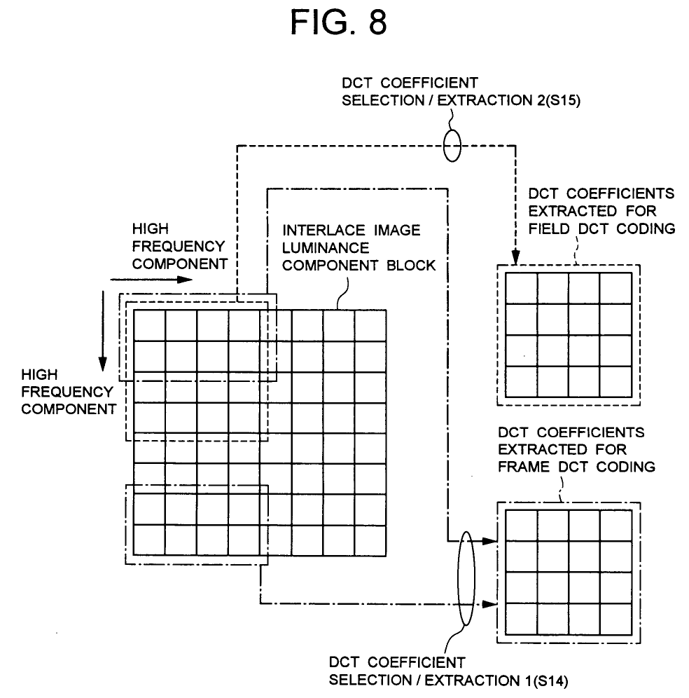

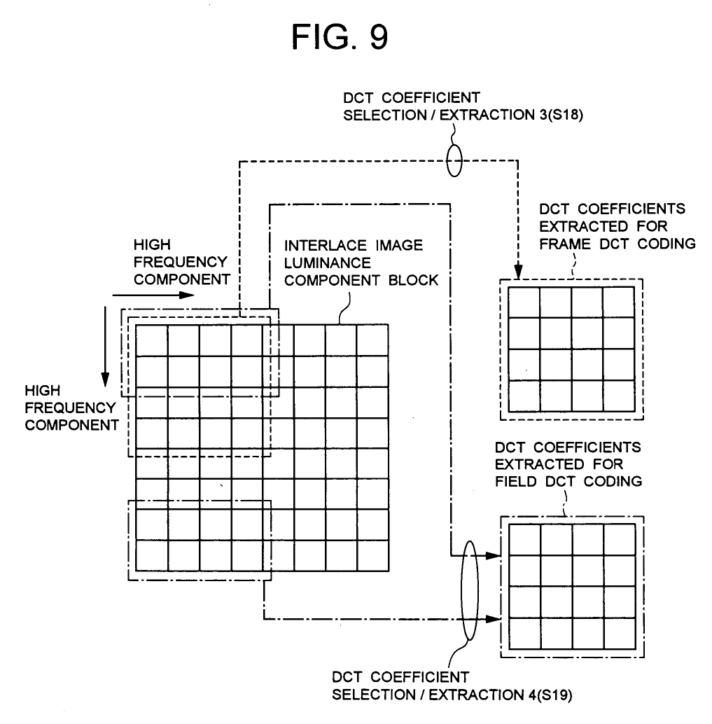

While the embodiment described above has shown an example of extracting DCT coefficients when a luminance component block and a color difference block are both reduced in resolution in the vertical direction to one half, implementations of the present invention are not limited to such an exemplary case. For example, FIGS. 8 and 9 show an embodiment when the resolution is reduced to one half both in the vertical and horizontal directions of each block.

For reference, FIG. 8 shows an exemplary case of processing a luminance component block, showing that the resolution is reduced to one half in the horizontal direction in the aforementioned FIG. 6. FIG. 9 in turn shows an example of processing on a color difference component block, showing that the resolution is further reduced to one half in the horizontal direction in the aforementioned FIG. 7. As is also apparent from FIGS. 8, 9, the processing is similar to the foregoing embodiment in the vertical direction, while only DCT coefficients of low frequency components are to be decoded in the horizontal direction. Since the hardware configuration and software configuration of such an embodiment are similar to the foregoing embodiment, description thereon is omitted.

1. A digital image signal decoder for decoding a digital image signal including data blocks each of which is a two-dimensional array of DCT coefficients derived through a discrete cosine transform of a unit image block composed of a plurality of adjacent pixel data, comprising:
an extracting circuit for selecting a partial area in each of the data blocks to extract the DCT coefficients included in the partial area; and
a decoding circuit for decoding the extracted DCT coefficients in accordance with the discrete cosine transform to reproduce image data included in the unit image block.

2. A digital image signal decoder according to claim 1, wherein said data block is a luminance component data block which stores DCT coefficients related to a luminance component of the unit image block.

3. A digital image signal decoder according to claim 2, wherein said extracting circuit selects low frequency areas both in the horizontal and vertical directions in the luminance component data block as the partial region when the discrete cosine transform is frame DCT encoding.

4. A digital image signal decoder according to claim 2, wherein said extracting circuit selects a low frequency area in the horizontal direction as well as a low frequency area and a high frequency area in the vertical direction in the luminance component data block as the partial area when the discrete cosine transform is field DCT encoding.

5. A digital image signal decoder according to claim 1, wherein said data block is a color difference component data block which stores DCT coefficients related to a color difference component of the unit image block.

6. A digital image signal decoder according to claim 5, wherein said extracting circuit selects low frequency areas both in the horizontal and vertical directions in the luminance component data block as the partial region when the discrete cosine transform is field DCT encoding.

7. A digital image signal decoder according to claim 5, wherein said extracting circuit selects a low frequency area in the horizontal direction as well as a low frequency area and a high frequency area in the vertical direction in the luminance component data block as the partial area when the discrete cosine transform is frame DCT encoding.

8. A digital image signal decoding method for decoding a digital image signal including data blocks each of which is a two-dimensional array of DCT coefficients derived through discrete cosine transform of a unit image block composed of a plurality of adjacent pixel data, comprising the steps of:
selecting a partial area in the data block to extract the DCT coefficients included in the partial area; and
decoding the extracted DCT coefficients in accordance with the discrete cosine transform to reproduce image data included in the unit image block.
